(19) United States
(12) Patent Application Publication
(10) Pub. No.: US 2026/0289730 A1
(43) Pub. Date: Sep. 24, 2026

(54) ELECTRONIC DEVICE, TERMINAL DEVICE AND INTELLIGENT SEAMLESS SWITCHING METHOD THEREOF

(71) Applicant: Acer Incorporated, New Taipei City (TW)

(72) Inventors: Yu-Shan RUAN, New Taipei City (TW); Liang-Chi CHEN, New Taipei City (TW)

(73) Assignee: Acer Incorporated, New Taipei City (TW)

(21) Appl. No.: 19/339,631

(22) Filed: Sep. 25, 2025

(30) Foreign Application Priority Data
Mar. 18, 2025 (TW) 114110084

(51) Int. Cl. G06T 5/50; G06V 40/16

(52) U.S. Cl. CPC G06T 5/50; G06V 40/172; G06T 2207/20221

(57) ABSTRACT

An electronic device, a terminal device and an intelligent seamless switching method thereof are provided. The electronic device includes a lens synchronization unit, an artificial intelligence inference unit and a screen mirror unit. The lens synchronization unit is used for obtaining at least one terminal lens image from the at least one terminal device. The artificial intelligence inference unit is used to identify that one of the at least one terminal device is a target terminal device according to at least a face recognition result of the at least one terminal camera image. The terminal camera image of the target terminal device has an authenticator. The image mirror unit superimposes the terminal camera image of the target terminal device on a screen image of the electronic device to obtain a composite mirror image. The composite mirror image is transmitted to the target terminal device.

This application claims the benefit of Taiwan application Serial No. 114110084, filed Mar. 18, 2025, the disclosure of which is incorporated by reference herein in its entirety.

### TECHNICAL FIELD

The disclosure relates in general to an electronic device, a terminal device and a controlling method thereof, and more particularly to an electronic device, a terminal device and an intelligent seamless switching method thereof.

### BACKGROUND

With the rapid development of technology, various electronic devices are constantly being introduced. People can use desktop computers, laptops, mobile phones or tablets to conduct video conferencing, video calls, live broadcasts and other activities.

However, video conferencing, video calling, live streaming, and other activities can currently only be performed on a single device. For example, when a user uses a laptop for video conferencing, video calling, or live streaming, any movement of the user requires the laptop to move with them, which is quite inconvenient. This is especially true when the user uses a desktop computer for video conferencing, video calling, or live streaming, as they cannot leave their seat. Once they leave their seat, they are unable to continue the video conferencing, video calling, or live streaming activity.

In order to provide users with more convenient usage, the industry is committed to developing various cross-device technologies to provide users with more convenient usage.

### SUMMARY

This disclosure is directed to an electronic device, a terminal device, and a method for intelligent seamless switching. Using Acer Real Time-Ai Media Mixer (ART-AIMMX) technology, the electronic device serves as the center of an intelligent environment, automatically and seamlessly integrating with the terminal device to achieve seamless, intelligent switching across devices.

According to one embodiment, an electronic device with intelligent seamless switching function is provided. The electronic device includes a lens synchronization unit, an artificial intelligence inference unit and a screen mirror unit. The lens synchronization unit is connected to at least one terminal device. The lens synchronization unit is used for obtaining at least one terminal lens image from the at least one terminal device. The artificial intelligence inference unit is connected to the lens synchronization unit. The artificial intelligence inference unit is used to identify that one of the at least one terminal device is a target terminal device according to at least a face recognition result of the at least one terminal camera image. The terminal camera image of the target terminal device has an authenticator. The screen mirror unit is connected to the artificial intelligence inference unit. The image mirror unit superimposes the terminal camera image of the target terminal device on a screen image of the electronic device to obtain a composite mirror image. The composite mirror image is transmitted to the target terminal device and displayed on the target terminal device.

According to another embodiment, an intelligent seamless switching method of an electronic device is provided. The intelligent seamless switching method includes the following steps. At least one terminal lens image is obtained from at least one terminal device. That one of the at least one terminal device is a target terminal device is identified according to at least a face recognition result of the at least one terminal camera image. The terminal camera image of the target terminal device has an authenticator. The terminal camera image of the target terminal device is superimposed on a screen image of the electronic device to obtain a composite mirror image. The composite mirror image is transmitted to the target terminal device and displayed the composite mirror image on the target terminal device.

According to an alternative embodiment, a terminal device with intelligent seamless switching function is provided. The terminal device includes a lens and a display unit. The lens is used to capturing at least one terminal lens image. The terminal lens image is transmitted to an electronic device. The display unit is used to display a composite mirror image. The composite mirror image is obtained by superimposing the terminal camera image on a screen image of the electronic device.

### BRIEF DESCRIPTION OF THE DRAWINGS

FIG. 1 illustrates a schematic diagram of an intelligent seamless switching technique for an electronic device according to an embodiment of the present disclosure.

FIG. 2 shows a block diagram of the electronic device and the terminal devices according to an embodiment of the present disclosure.

FIG. 3 illustrates a flow chart of an intelligent seamless switching method for the electronic device according to an embodiment of the present disclosure.

FIG. 4 illustrates a detailed flowchart of step S120 in one embodiment of the present disclosure.

FIG. 5 illustrates the step S130.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

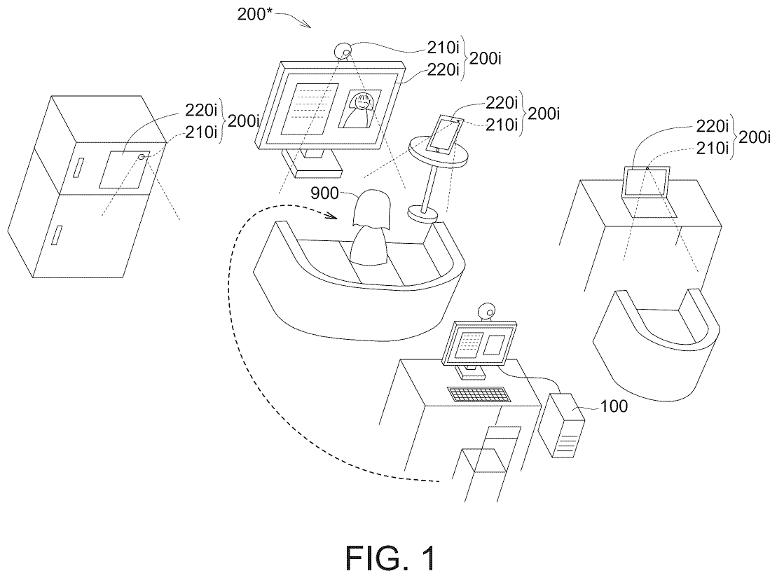

Please refer to FIG. 1, which illustrates a schematic diagram of an intelligent seamless switching technique for an electronic device 100 according to an embodiment of the present disclosure. The electronic device 100 is, for example, a desktop computer, a notebook computer, a mobile phone, a tablet computer, or a smart home appliance. FIG. 1 illustrates the electronic device 100 using a desktop computer as an example. In a certain environment, in addition to the electronic device 100, there are also numerous terminal devices 200i. The terminal device(s) 200i is/are, for example, a desktop computer, a notebook computer, a mobile phone, a tablet computer, or a smart home appliance.

While using the electronic device 100 for a video conference, user 900 may need to move to the sofa. The terminal device 200i (e.g., a smart TV) located in front of the sofa captures the user 900 through its lens 210i. This terminal device 200i is identified as a target terminal device 200* and seamlessly switches between it and the electronic device 100. The user 900 could then continue the video conference using the terminal device 200i located in front of the sofa.

If the user 900 moves to another terminal device 200i (such as a smart refrigerator), the video conference could be seamlessly switched to that terminal device 200i. This seamless cross-device switching allows the users to conveniently move around and conduct video conferences.

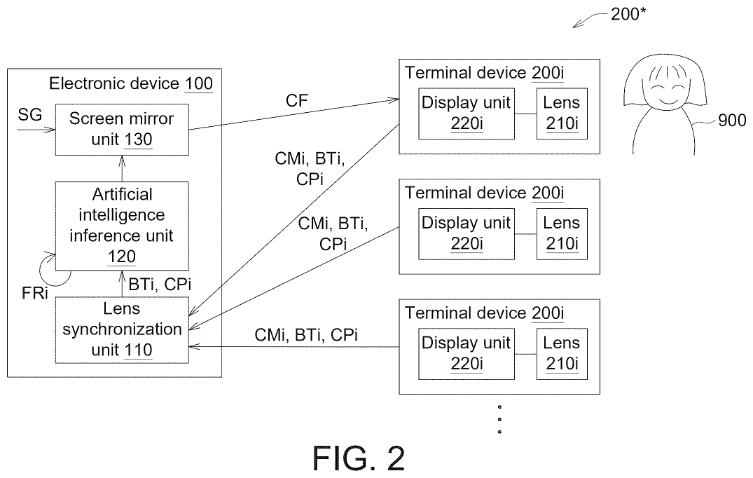

Please refer to FIG. 2, which shows a block diagram of the electronic device 100 and the terminal devices 200i according to an embodiment of the present disclosure. The electronic device 100 includes a lens synchronization unit 110, an artificial intelligence inference unit 120, and a screen mirror unit 130. Each of the terminal devices 200i includes a lens 210i and a display unit 220i. The lens synchronization unit 110, the artificial intelligence inference unit 120, and/or the screen mirror unit 130 is, for example, a circuit, a circuit board, a memory device storing program code, or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

In this disclosure, Acer Real Time-Ai Media Mixer (ART-AIMMX) technology is used to position the electronic device 100 as the center of a smart environment, automatically and seamlessly integrating it with the terminal device 200i to achieve seamless intelligent switching across devices. The following flowchart details the operation of each component.

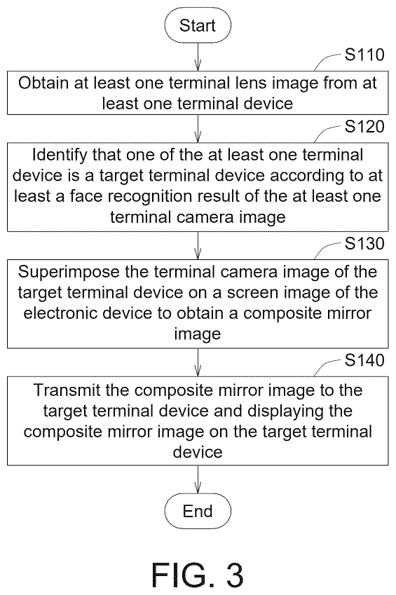

Please refer to FIG. 3, which illustrates a flow chart of an intelligent seamless switching method for the electronic device 100 according to an embodiment of the present disclosure. The intelligent seamless switching method includes steps S110 to S140.

In the step S110, as shown in FIG. 2, the lens synchronization unit 110 of the electronic device 100 obtains at least one terminal lens image CMi from the at least one terminal device 200i. In this step, the electronic device 100 and the terminal device 200i establish a Bluetooth connection and pair with each other. The electronic device 100 and the terminal device 200i are also located in the same wireless network domain.

In this step, the electronic device 100 first activates the ART-AIMMX and confirms that it is connected to a stable network and has Bluetooth enabled. The ART-AIMMX is Acer's proprietary DMFT technology, used to capture the image inputted to the electronic device 100. This disclosure utilizes this technology to obtain the terminal lens image CMi.

At the same time, the terminal device 200i also launches the ART-AIMMX, turns on Bluetooth connection, and ensures it is connected to the same Wi-Fi network as the electronic device 100. The terminal device 200i then completes pairing with the electronic device 100. Once pairing is complete, both of the electronic device 100 and the terminal device 200i will see a list of connected devices on the ART-AIMMX interface.

The lens 210i of the terminal device 200i activates and captures the terminal lens image CMi. The contents of the terminal lens image CMi vary depending on the location of the terminal device 200i.

When the electronic device 100 is connected to the terminal device 200i, the terminal lens image CMi is automatically transmitted from the terminal device 200i to the electronic device 100 through the ART-AIMMX technology. The terminal device 200i continuously transmits the terminal lens image CMi to the electronic device 100 in real time. This terminal lens image CMi may or may not be displayed on the electronic device 100 (for example, the electronic device 100 may have a screen, be connected to a screen, or not have a screen).

In the electronic device 100, the lens synchronization unit 110 is the execution unit for the ART-AIMMX technology, and its main function is to provide the terminal lens image CMi and the status information of the lens 210i.

Next, in the step S120, as shown in FIG. 2, the artificial intelligence inference unit 120 identifies one of the terminal devices 200i as the target terminal device 200* according to at least the face recognition result FRi of the terminal lens image CMi. Since the terminal device 200i is located at different locations, the content of the terminal lens image CMi will also be different. The authenticator 900 may move in front of one of the terminal devices 200i, so one terminal lens image CMi may contain the authenticator 900. The face recognition result FRi contains the recognition confidence level of each of the terminal lens images CMi for the authenticator 900. The higher the recognition confidence level, the higher the probability that the terminal lens image CMi contains the authenticator 900. The terminal device 200i corresponding to the terminal lens image CMi containing the authenticator 900 is identified as the target terminal device 200*.

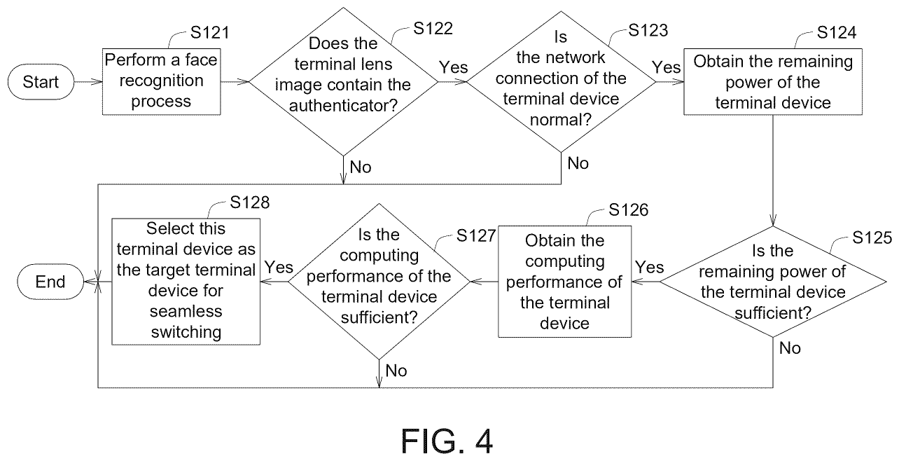

In addition to the face recognition result FRi, the artificial intelligence inference unit 120 could further determine which terminal device 200i is the target terminal device 200* according to a remaining power BTi and a computing performance CPi. Please refer to FIG. 4, which illustrates a detailed flowchart of step S120 in one embodiment of the present disclosure. The step S120, for example, includes steps S121 to S128. In the step S121, as shown in FIG. 2, the artificial intelligence inference unit 120 performs a face recognition process to obtain the face recognition result FRi. The face recognition process primarily determines whether the authenticator 900 is present in the terminal lens image CMi.

Next, in the step S122, as shown in FIG. 2, the artificial intelligence inference unit 120 determines whether the terminal lens image CMi contains the authenticator 900. If the terminal lens image CMi contains the authenticator 900, the process proceeds to the step S123.

In the step S123, as shown in FIG. 2, the artificial intelligence inference unit 120 determines whether the network connection of the terminal device 200i is normal. For example, the following methods could be used to test network connectivity: whether the network card is enabled and has the correct IP address; whether the gateway could be pinged; whether the public DNS could be pinged (e.g., 8.8.8.8); whether the domain name could be resolved (e.g., nslookup google.com); whether Traceroute indicates that packets are not blocked; whether there are any firewall or proxy restrictions; and whether the Wi-Fi signal is strong and free of excessive interference.

If the network connection of terminal device 200i is normal, the process proceeds to the step S124.

Next, in the step S124, as shown in FIG. 2, the artificial intelligence inference unit 120 obtains the remaining power BTi of the terminal device 200i. In this step, the remaining power BTi is obtained by measuring battery voltage, current, temperature, and other information using the battery sensors in the terminal device 200i. The remaining power is then calculated by the embedded controller (EC) and battery management system (BMS) and transmitted to the motherboard. This data could be read via Advanced Configuration and Power Interface (ACPI).

Then, in the step S125, as shown in FIG. 2, the artificial intelligence inference unit 120 determines whether the remaining power BTi of the terminal device 200i is sufficient. If the remaining power BTi of the terminal device 200i is sufficient, the process proceeds to the step S126. In one embodiment, if the terminal device 200i is connected to the adaptor, the remaining power BTi of the terminal device 200i is determined to be sufficient.

Next, in the step S126, as shown in FIG. 2, the artificial intelligence inference unit 120 obtains the computing performance CPi of the terminal device 200i. The computing performance CPi includes, for example, central processing unit (CPU) usage (%), clock speed, temperature, and power consumption; graphics processing unit (GPU) usage, memory usage, and temperature; RAM total capacity, used capacity, and swap usage (virtual memory); and HDD/SSD read/write speed (IOPS, MB/s), usage (%), and storage space. This information could be obtained through Hardware Performance Counters (HPC), ACPI, and/or built-in monitoring tools in the operating system.

Then, in the step S127, as shown in FIG. 2, the artificial intelligence inference unit 120 determines whether the computing performance CPi of the terminal device 200i is sufficient. If the computing performance CPi of the terminal device 200i is sufficient, the process proceeds to step S127.

In the step S128, the artificial intelligence inference unit 120 selects this terminal device 200i as the target terminal device 200* for seamless switching.

According to the embodiment of FIG. 4, the terminal device 200i could ensure seamless switching when the terminal lens image CMi includes the authenticator 900, the network connection is normal, the remaining power BTi is sufficient, and the computing performance CPi is sufficient.

In one embodiment, if one terminal lens image CMi has a non-authenticator, the terminal device 200i is prevented from seamlessly switching and a warning notification is sent.

In another embodiment, if the target terminal device 200* that is undergoing seamless switching suddenly experiences a network interruption, the step S120 may be repeatedly executed to select a new terminal device 200i as the new target terminal device 200*.

In another embodiment, if the target terminal device 200* that is being seamlessly switched suddenly runs out of power, the step S120 may be repeatedly executed to select a new terminal device 200i as the new target terminal device 200*.

In one embodiment, the face recognition result FRi is the most important, and the remaining importance is as follows: the network connection, the remaining power BTi, and the computing performance CPi. The importance of these decision factors could be controlled and changed by setting the decision order or weight.

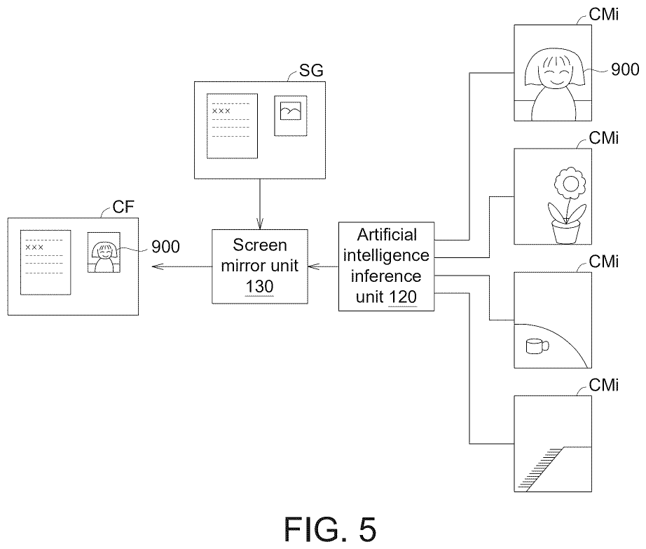

Next, please refer to FIG. 5, which illustrates the step S130. In the step S130, the screen mirror unit 130 superimposes the terminal lens image CMi of the target terminal device 200* on the screen image SG of the electronic device 100 to obtain a composite mirror image CF.

The screen image SG of the electronic device 100 could be, for example, a video conferencing screen, a medical monitoring screen, a teaching screen, or a music playback screen. The screen mirror unit 130 temporarily stores the screen image SG and the terminal lens image CMi in a custom memory space and overlays the composite mirror image CF onto the display unit 220i of the target terminal device 200* via network technologies such as WiFi-direct and hotspot.

In one embodiment, the screen mirror unit 130 captures the composite mirror image CF according to a screen update rate of the target terminal device 200* to ensure that the image could be stably displayed when mirrored to the target terminal device 200*.

The following examples illustrate various implementation scenarios.

In a smart office and seamless work environment, seamless communication and collaboration across multiple devices is possible while working from home. For example, a designer works from home with a smart TV, tablet, and laptop. She needs to participate in a video conference and share design drafts with her team while also being able to take care of her children.

First, she joined a video conference from her laptop in her study. The system automatically set the laptop's camera lens as the source for the video window. She presented her design to the team and provided an explanation.

Then, the child suddenly ran into the living room to play. Worried about the child, she took her tablet with her and went to the living room. The system automatically detected her presence in front of the tablet, switched the video window in the video conference to the image of her captured by the tablet, and pushed the conference screen to the tablet for display.

Then, in the living room, the camera connected to the smart TV captured her image, and the system automatically switched the video window to the smart TV's external camera's view of her. The smart TV also automatically synchronized the meeting content. After quieting her children, she returned to her study and continued to concentrate on the meeting, with the laptop's camera lens once again becoming the primary source of the video window.

After the meeting, the team asked to review the design details. She displayed the design on a smart TV (using a video screen that was displayed simultaneously on the smart TV) to facilitate feedback from all family members, allowing her to quickly complete the revisions.

Furthermore, in smart healthcare and remote care scenarios, seamless cross-device connectivity allows medical staff and patients to monitor and communicate uninterruptedly across devices. For example, when a patient is transferred from a ward to a clinic, health monitoring data (heart rate, blood pressure, blood oxygen level, etc.) could be automatically transferred to the doctor's mobile device, ensuring uninterrupted medical information flow and achieving seamless medical information transfer from the ward to the clinic.

Alternatively, when doctors or nurses switch from computers to mobile devices, video diagnosis or patient data could be synchronized and continued without affecting communication and monitoring, achieving seamless remote care switching.

Furthermore, in educational and remote learning contexts, students and teachers could seamlessly switch classroom content between devices, enhancing the learning experience. For example, teachers could seamlessly switch from their laptop to an interactive whiteboard or projector, while students' devices (tablets, laptops) could also synchronize content in real time, achieving continuous, uninterrupted smart classroom technology.

Alternatively, students could start reading an e-book on their computer and, when they move to another space, the content will automatically sync to their e-book reader or mobile phone, ensuring uninterrupted learning and enabling a cross-device learning experience.

Furthermore, in entertainment scenarios, as users move between spaces, music or videos could automatically and seamlessly switch to the new device without interruption. For example, if a user is watching a movie in the living room and then moves to the bedroom, the system automatically switches to the bedroom screen or projector and synchronizes the playback progress, realizing smart home theater technology.

Alternatively, when a user moves from one room to another, the audio system can dynamically shift the audio source based on the user's location, ensuring that the music always revolves around the user, achieving seamless and continuous music playback throughout the house.

According to the intelligent seamless switching method disclosed in the above embodiment, at least the following functions could be achieved:
“Cross-device Communication”: Enable Seamless communication between devices within a smart environment.
“Auto-switch video screen”: Automatically switch the screen to the mobile phone during a video conference (current mobile video software displays the camera screens of different devices together when logged in simultaneously, making it impossible to display only the camera screen of the person's main location).
“Smart Home”: Automatically transfer the mobile phone video screen to the smart TV in the home environment.
“AI PC Core”: As the core control technology of the smart environment, it coordinates communication and operations between various devices.
“Convenient Lifestyle”: Through intelligent technology, it brings users a more convenient and intelligent lifestyle.

The intelligent seamless switching method disclosed in the above embodiments could achieve numerous benefits: It improves user convenience between devices, allowing users to switch between devices without interrupting communication; enhances workflow fluidity and consistency, improving work efficiency; and provides coordination and management of the overall smart environment, enhancing quality of life and reducing tedious operations in daily life. It supports seamless switching between devices, and AI-based user detection instantly determines the user's device and automatically switches the video screen, eliminating cumbersome manual operations. Using “authenticator detection” as the primary trigger, dynamic screen switching enhances system flexibility and real-time performance, enabling more accurate application in multi-device interaction scenarios.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An electronic device with intelligent seamless switching function, comprising:
a lens synchronization unit, connected to at least one terminal device, wherein the lens synchronization unit is used for obtaining at least one terminal lens image from the at least one terminal device;
an artificial intelligence inference unit, connected to the lens synchronization unit, wherein the artificial intelligence inference unit is used to identify that one of the at least one terminal device is a target terminal device according to at least a face recognition result of the at least one terminal camera image, and the terminal camera image of the target terminal device has an authenticator; and
a screen mirror unit, connected to the artificial intelligence inference unit, wherein the image mirror unit superimposes the terminal camera image of the target terminal device on a screen image of the electronic device to obtain a composite mirror image, and the composite mirror image is transmitted to the target terminal device and displayed on the target terminal device.

2. The electronic device with intelligent seamless switching function according to claim 1, wherein the electronic device is a computer, and one of the at least one terminal device is a mobile phone, a tablet computer or a smart home appliance.

3. The electronic device with intelligent seamless switching function according to claim 1, wherein the electronic device and the at least one terminal device establish a Bluetooth connection.

4. The electronic device with intelligent seamless switching function according to claim 1, wherein the electronic device and the at least one terminal device are located in identical network domain.

5. The electronic device with intelligent seamless switching function according to claim 1, wherein the at least one terminal lens image is captured by a lens of the at least one terminal device.

6. The electronic device with intelligent seamless switching function according to claim 1, wherein the at least one terminal device instantly and continuously transmits the at least one terminal lens image to the electronic device.

7. The electronic device with intelligent seamless switching function according to claim 1, wherein the artificial intelligence inference unit determines that one of the at least one terminal device is the target terminal device according to the face recognition result, a remaining power and a computing performance of the at least one terminal device.

8. The electronic device with intelligent seamless switching function according to claim 1, wherein the screen mirror unit captures the composite mirror image according to a frame refresh rate of the target terminal device.

9. The electronic device with intelligent seamless switching function according to claim 1, wherein the screen image of the electronic device is a video conference screen, a medical monitoring screen, a teaching screen, or a music playing screen.

10. An intelligent seamless switching method of an electronic device, comprising:
obtaining at least one terminal lens image from at least one terminal device;
identifying that one of the at least one terminal device is a target terminal device according to at least a face recognition result of the at least one terminal camera image, wherein the terminal camera image of the target terminal device has an authenticator;
superimposing the terminal camera image of the target terminal device on a screen image of the electronic device to obtain a composite mirror image; and
transmitting the composite mirror image to the target terminal device and displaying the composite mirror image on the target terminal device.

11. The intelligent seamless switching method of the electronic device according to claim 10, wherein the electronic device is a computer, and one of the at least one terminal device is a mobile phone, a tablet computer or a smart home appliance.

12. The intelligent seamless switching method of the electronic device according to claim 10, wherein in the step of obtaining the at least one terminal lens image from the at least one terminal device, the electronic device and the at least one terminal device establish a Bluetooth connection, and the electronic device and the at least one terminal device are located in identical network domain.

13. The intelligent seamless switching method of the electronic device according to claim 10, wherein the at least one terminal lens image is captured by a lens of the at least one terminal device.

14. The intelligent seamless switching method of the electronic device according to claim 10, wherein the at least one terminal device instantly and continuously transmits the at least one terminal lens image to the electronic device.

15. The intelligent seamless switching method of the electronic device according to claim 10, wherein in the step of identifying that one of the at least one terminal device is the target terminal device, one of the at least one terminal device is identified as the target terminal device according to the face recognition result, a remaining power and a computing performance of the at least one terminal device.

16. The intelligent seamless switching method of the electronic device according to claim 10, wherein in the step of obtaining the composite mirror image, the composite mirror image is captured according to a frame refresh rate of the target terminal device.

17. The intelligent seamless switching method of the electronic device according to claim 10, wherein the screen image of the electronic device is a video conference screen, a medical monitoring screen, a teaching screen, or a music playing screen.

18. A terminal device with intelligent seamless switching function, comprising:
a lens, used to capturing at least one terminal lens image, wherein the terminal lens image is transmitted to an electronic device; and
a display unit, used to display a composite mirror image, wherein the composite mirror image is obtained by superimposing the terminal camera image on a screen image of the electronic device.

19. The terminal device with intelligent seamless switching function according to claim 18, wherein the terminal device is a mobile phone, a tablet computer or a smart home appliance.

20. The terminal device with intelligent seamless switching function according to claim 18, wherein the electronic device and the terminal device are located in identical network domain.
